(19) United States
(12) Patent Application Publication
(10) Pub. No.: US 2014/0320029 A1
(43) Pub. Date: Oct. 30, 2014

(54) POWER CONVERTER CIRCUIT AND SOLAR POWER SYSTEM HAVING SAME

(71) Applicant: ZETA FAR EAST LIMITED, Hong Kong (HK)

(72) Inventor: Paul John Tyrrell, Hong Kong (HK)

(73) Assignee: ZETA FAR EAST LIMITED, Hong Kong (HK)

(21) Appl. No.: 14/221,322

(22) Filed: Mar. 21, 2014

Related U.S. Application Data
(60) Provisional application No. 61/816,818, filed on Apr. 29, 2013.

(51) Int. Cl. H02J 7/35; H05B 33/08

(52) U.S. Cl. CPC H02J 7/35; H05B 33/0806
USPC 315/161; 320/101

(57) ABSTRACT

A power converter circuit includes: a first transistor being connected with a positive node and a negative node of a photovoltaic panel; a second transistor being connected with the first transistor and the negative node of the photovoltaic panel; a first controller circuit being configured to measure the voltage at a reference node and adjust the gate voltage of the first and second transistors respectively; a third transistor being connected with the reference node and an output node; and a second controller circuit being configured to control the gate voltage of the third transistor. The reference node is connected to the second transistor through a LC network. The first controller circuit is configured to turn off the first and second transistors when the voltage at the reference node exceeds a threshold. The second controller circuit is configured to prevent current from being fed back through the LC network.

### CROSS-REFERENCE TO RELATED APPLICATIONS

This application claims the benefit of U.S. Provisional Patent Application No. 61/816,818 filed on Apr. 29, 2013; the contents of which is hereby incorporated by reference.

### FIELD OF THE PATENT APPLICATION

The present patent application generally relates to solar power electronics and more specifically to a power converter circuit and a solar power system having the same with particular application in solar powered LED lighting in an urban environment.

### BACKGROUND

Conventional solar power system includes a single battery pack (which includes a number of batteries), a single solar panel array which includes a number of PV (photovoltaic) panels, and a single charger/controller. A number of LED luminaires are wired into the charger/controller. High current and bulky conductors are needed for the PV panels and the batteries as they have to carry the full system current. All components must be wired up to a central charger/controller using dedicated cables. Each application must be sized and each component must be specified at the outset to suit the power rating and the physical layout. It is difficult to modify or extend the system after installation. A relatively high level of expertise is required to install the system.

### SUMMARY

The present patent application is directed to a power converter circuit for charging a battery and a solar power system having the power converter circuit. In one aspect, the power converter circuit includes: a first transistor being connected with a positive node and a negative node of a photovoltaic panel; a second transistor being connected with the first transistor and the negative node of the photovoltaic panel; a first controller circuit being configured to measure the voltage at a reference node and adjust the gate voltage of the first and second transistors respectively; a third transistor being connected with the reference node and an output node; and a second controller circuit being configured to control the gate voltage of the third transistor. The reference node is connected to the second transistor through a LC network. The first controller circuit is configured to turn off the first and second transistors when the voltage at the reference node exceeds a threshold. The second controller circuit is configured to prevent current from being fed back through the LC network.

The first, second and third transistors may be MOSFETS. The first controller circuit may be configured to generate out of phase PWM signals to control the gate voltage of the first and second transistors respectively. The threshold may be about 1 to 2 volts above the fully charged voltage of the battery. The first controller circuit may be configured to adjust the gate voltage of the first and second transistors respectively so that a preset voltage between the positive and negative nodes of the photovoltaic panel is maintained.

The first controller circuit may be configured to turn off the gate voltage of the first and second transistors for a predetermined period within every predetermined interval. During the predetermined period, the open circuit voltage of the photovoltaic panel may be measured repeatedly at a predetermined frequency, and the first controller circuit may be configured to turn on the gate voltage of the first and second transistors when the difference between two consecutive measurements is less than a predetermined amount.

In another aspect, the present patent application provides a solar power system that includes: a plurality of photovoltaic panels, each photovoltaic panel including a charging node configured to provide a voltage limited current output; a plurality of batteries, each battery including a sensing node configured to preventing the battery from being overcharged or the system from being overloaded; a plurality of LED luminaires, each LED luminaire including a LED driving and control node configured to control the brightness and on/off status of the LED luminaire; and a master controller being connected with the photovoltaic panels, the batteries and the LED luminaires through a bus, and configured to coordinate the operations thereof. The charging node includes a power converter circuit for charging a battery. The power converter circuit includes: a first transistor being connected with a positive node and a negative node of a photovoltaic panel; a second transistor being connected with the first transistor and the negative node of the photovoltaic panel; a first controller circuit being configured to measure the voltage at a reference node and adjust the gate voltage of the first and second transistors respectively; a third transistor being connected with the reference node and an output node; and a second controller circuit being configured to control the gate voltage of the third transistor.

The reference node may be connected to the second transistor through a LC network. The first controller circuit may be configured to turn off the first and second transistors when the voltage at the reference node exceeds a threshold. The second controller circuit may be configured to prevent current from being fed back through the LC network.

The master controller may include a wireless link configured to enable remote system monitoring and control. The bus may be a two wire power bus or a four wire power and data bus. The master controller may be configured to turn off all the charging nodes when all the batteries are fully charged.

The master controller may be configured to collect data from each charging node to record how much power has been produced on a day to day basis. The sensing node of each battery may be configured to allow the battery to be disconnected from the bus when the battery is fully charged. The master controller may be configured to instruct a battery to be disconnected from the bus. Through the LED driving and control node, each luminaire may be configured to send data indicating the performance of the luminaire back to the master controller.

In yet another aspect, the present patent application provides a solar power system that includes: at least a photovoltaic panel, the photovoltaic panel including a charging node configured to provide a current output; at least a battery, the battery including a sensing node configured to preventing the battery from being overcharged or the system from being overloaded; at least an LED luminaire, the LED luminaire including a LED driving and control node configured to control the LED luminaire; and a master controller being connected with the photovoltaic panel, the battery and the LED luminaire through a bus, and configured to coordinate the operations thereof. The charging node includes a power converter circuit for charging a battery. The power converter circuit includes: a first transistor being connected with a positive node and a negative node of a photovoltaic panel; a second transistor being connected with the first transistor and the negative node of the photovoltaic panel; and a first controller circuit being configured to measure the voltage at a reference node and adjust the gate voltage of the first and second transistors respectively. The reference node is connected to the second transistor through a LC network. The first controller circuit is configured to turn off the first and second transistors when the voltage at the reference node exceeds a threshold.

The threshold may be about 1 to 2 volts above the fully charged voltage of the battery. The first controller circuit may be configured to turn off the gate voltage of the first and second transistors for a predetermined period within every predetermined interval. During the predetermined period, the open circuit voltage of the photovoltaic panel may be measured repeatedly at a predetermined frequency, and the first controller circuit may be configured to turn on the gate voltage of the first and second transistors when the difference between two consecutive measurements is less than a predetermined amount.

### BRIEF DESCRIPTIONS OF THE DRAWINGS

FIG. 1 is a schematic diagram of a solar power system according to an embodiment of the present patent application.

FIG. 2 is a schematic diagram of a power converter circuit for charging a battery according to an embodiment of the present patent application.

### DETAILED DESCRIPTION

Reference will now be made in detail to a preferred embodiment of the power converter circuit and the solar power system having the same disclosed in the present patent application, examples of which are also provided in the following description. Exemplary embodiments of the power converter circuit and the solar power system having the same disclosed in the present patent application are described in detail, although it will be apparent to those skilled in the relevant art that some features that are not particularly important to an understanding of the power converter circuit and the solar power system having the same may not be shown for the sake of clarity.

Furthermore, it should be understood that the power converter circuit and the solar power system having the same disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

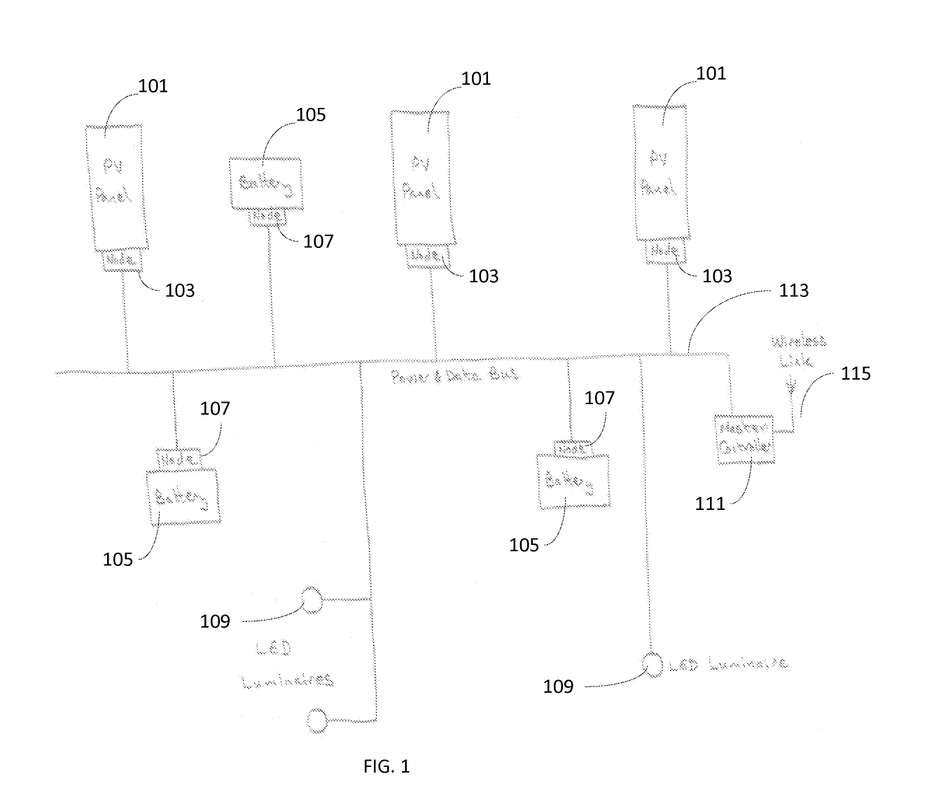

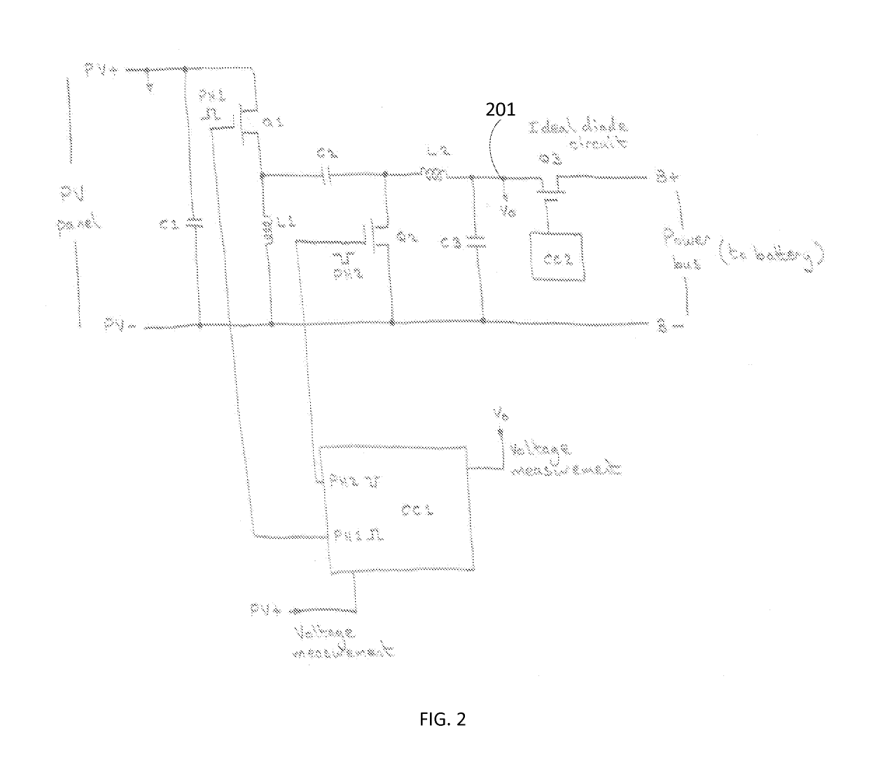

FIG. 1 is a schematic diagram of a solar power system according to an embodiment of the present patent application. Referring to FIG. 1, the solar power system includes: a plurality of photovoltaic panels 101, each photovoltaic panel 101 including a charging node 103 configured to provide a voltage limited current output; a plurality of batteries 105, each battery 105 including a sensing node 107 configured to preventing the battery 105 from being overcharged or the system from being overloaded; a plurality of LED luminaires 109, each LED luminaire 109 including a LED driving and control node configured to control the brightness and on/off status of the LED luminaire 109; and a master controller 111 being connected with the photovoltaic panels 101, the batteries 105 and the LED luminaires 109 through a bus 113, and configured to coordinate the operations thereof. The charging node 103 includes a power converter circuit for charging a battery. The power converter circuit is illustrated in FIG. 2 and will be described in more detail hereafter.

Referring to FIG. 1, each solar panel 101 (also referred to as “photovoltaic panel” or “PV panel”) has been attached with a charging node 103, producing a voltage limited current output which can charge any battery connected to the network. Each battery 105 has a sensing node 107, preventing the battery from being overcharged and providing current limiting to prevent overload of the network wiring. Each LED luminaire 109 has a built-in LED driving and control node. This allows each lamp to be controlled in brightness and turned on and off via the network. Each system has a central master controller 111, which coordinates the operations of all the other components. In this embodiment, the master controller 111 may also include a WiFi or other wireless link 115 configured to enable remote system monitoring and control.

In this embodiment, a range of LED luminaires can be constructed to be compatible with the solar power system so that they can be mixed and matched on site, without the requirement of redesigning the whole system.

The bus 113 is a four wire power and data bus in this embodiment. There are 2 high current wires distributing power around and 2 low current wires providing a data link to all nodes. Premade cable assemblies of various lengths can be concatenated and torn-off to create any required physical layout. In an alternative embodiment, the bus 113 is a two wire power bus and wireless links are used to exchange data between nodes.

The charging node 103 is configured to convert the voltage output from the PV panel 101 and generate a current in the power bus 113 to charge any batteries connected to the power bus. The charging node 103 includes an inverse single-ended primary-inductor converter (SEPIC) power converter circuit (referring to FIG. 2) to enable the PV panel voltage to be stepped up or down to suit the battery voltage. The maximum output voltage of this node is set to be just above the fully charged battery voltage. The power converter circuit operates open loop, apart from the maximum voltage trip point. This means that the connected batteries determine the power bus voltage.

The PV panel node 103 operates a maximum power point tracking (MPPT) function to extract maximum power from the PV panel 101 under any insolation value. It operates by adjusting the power converter PWM value to maintain a constant preset PV panel voltage.

FIG. 2 is a schematic diagram of a power converter circuit for charging a battery according to an embodiment of the present patent application. The circuit is a modified single-ended primary-inductor converter (SEPIC) circuit. Referring to FIG. 2, the power converter circuit includes: a first transistor Q1 being connected with a positive node PV+ and a negative node PV− of a photovoltaic panel; a second transistor Q2 being connected with the first transistor Q1 and the negative node PV− of the photovoltaic panel; a first controller circuit CC1 being configured to measure the voltage Vₒ at a reference node 201 and adjust the gate voltage of the first and second transistors Q1 and Q2 respectively; a third transistor Q3 being connected with the reference node 201 and an output node B+; and a second controller circuit CC2 being configured to control the gate voltage of the third transistor Q3. The reference node 201 is connected to the second transistor Q2 through a LC network (L2 and C3). The first controller circuit CC1 is configured to turn off the first and second transistors Q1 and Q2 when the voltage Vₒ at the reference node 201 exceeds a threshold. The second controller circuit CC2 is configured to prevent current from being fed back through the LC network (L2 and C3).

More specifically in this embodiment, referring to FIG. 2, Q1 and Q2 are the high side and low side power MOSFETS, driven by voltage signals PH1 and PH2, which are out of phase PWM signals generated by controller circuit CC1. C1, C2, C3, L1 and L2 are capacitors and inductors used in the standard circuit.

It is noted that in this circuit, there is no output voltage feedback loop to provide a fixed output voltage. Instead, the output voltage Vₒ is measured by CC1 and is used to turn off PH1 and PH2 when its value exceeds a threshold. This threshold is set to be approximately 1 to 2 volts above the battery fully charged voltage. This prevents an overvoltage occurring at Vo in the event of a battery disconnection or open circuit at the output.

During normal operation the output voltage Vₒ will be controlled by the battery, which presents a low impedance when being charged. Vₒ will rise as the battery charges up. The PWM value of PH1 and PH2 is adjusted up or down to maintain the preset PV panel voltage, implementing the MPPT function. In addition, PH1 and PH2 are turned off for a very brief period within every 30 seconds (the predetermined interval may have lengths other than 30 seconds in other embodiments). During this predetermined brief period the open circuit voltage of the PV panel is measured. The pre-set panel voltage for MPPT control is set to a value of (typically) 75% of the open circuit voltage.

It is noted that the length of the brief turn off period is determined as follows. When PH1 and PH2 are turned off, the PV panel voltage will rise up at a rate determined by the PV panel capacitance, the value of C1 in the circuit and the solar insolation. The PV panel voltage is then measured every 10 mS. When the difference between 2 consecutive measurements is less than a predetermined amount (typically 50 mV-100 mV) the PV panel voltage is then close to the top of its rising curve and the measured value is saved as the open circuit voltage. PH1 and PH2 are then reapplied for the remainder of the 30 second period.

Referring to FIG. 2, an ideal diode circuit based around MOSFET Q3 and the control circuit CC2 are used. The purpose is to prevent battery current from feeding back through L2 and Q2.

It is understood that in the embodiment, currents from multiple PV panel nodes 103 are summed onto the power bus 113. Unlike constant voltage chargers, in this embodiment, multiple node outputs can be connected in parallel without having to accurately match their voltages. The master controller 111 can turn off all the PV panel nodes 103 when all the batteries are fully charged. The master controller 111 can also collect data from each PV panel node 103 to record how much power has been produced on a day to day basis.

Referring to FIG. 1, the sensing node 107 of each battery is configured to allow the battery 105 to be disconnected from the power bus 113 when the battery 105 is fully charged. The currents from the PV panel nodes 103 will then continue to charge the other still partly charged batteries. In addition the master controller 111 can instruct a battery 105 to be disconnected from the power bus 113. In this way the master controller 111 can perform a battery balancing function. This is particularly important where multiple PV panels 101 receive different amounts of insolation due to their location. In a system with long cable runs, there will be voltage drops along the power bus cables. The battery balancing function is essential in this case to obtain maximum longevity from all the batteries.

The LED driving and control node includes the driver circuit for the LED luminaires 109 and an interface to the bus 113. Each LED luminaire 109 can be turned on and off or dimmed separately if desired. In addition, through the LED driving and control node, each luminaire 109 can send data back to the master controller 111 indicating its performance.

LED luminaires can take many physical shapes and power ratings, all with a common power and data connection. Exemplary luminaires are round down-lights or linear fluorescent luminaire replacements.

The master controller 111 coordinates all functions of the nodes. It balances the charge on various batteries and turns all the luminaires on and off at dusk and dawn. It also records data from each node, which can be accessed locally or off-site via a wireless link to determine overall system performance.

In the above embodiments, a flexible solar power system is provided. Multiple batteries, solar panels and LED luminaires may be connected to a power and data bus, providing greater flexibility in configuration. For any particular application, prewired components can be connected together to create a network of batteries, solar panels and luminaires, without having to design and size up a different system for every application.

This flexible system is particularly appropriate for constructing solar powered lighting systems for urban walkways or multiple pole mounted luminaires, where components are distributed over a distance of several hundred meters. It allows factory made components and cable assemblies to be plugged together on-site to suit the location. The amount of system design needed at the outset is reduced and relatively unskilled labor can be used on site.

Because the batteries, PV panels and LED luminaires are distributed along the power bus, there are no bulky conductors carrying full system current. The system is essentially freeform, enabling the exact configuration to be determined upon installation. Preassembled modules and cable assemblies are plugged together on-site. Extra modules or components can be connected at a later stage to extend the system or add extra LED luminaires where system monitoring has determined that more solar energy is available than what was initially estimated. A relatively low level of expertise is required to mount the modules and plug them together.

While the present patent application has been shown and described with particular references to a number of embodiments thereof, it should be noted that various other changes or modifications may be made without departing from the scope of the present invention.

What is claimed is:

1. A power converter circuit for charging a battery, the power converter circuit comprising:
a first transistor being connected with a positive node and a negative node of a photovoltaic panel;
a second transistor being connected with the first transistor and the negative node of the photovoltaic panel;
a first controller circuit being configured to measure the voltage at a reference node and adjust the gate voltage of the first and second transistors respectively;
a third transistor being connected with the reference node and an output node; and
a second controller circuit being configured to control the gate voltage of the third transistor;
wherein:
the reference node is connected to the second transistor through a LC network;
the first controller circuit is configured to turn off the first and second transistors when the voltage at the reference node exceeds a threshold; and
the second controller circuit is configured to prevent current from being fed back through the LC network.

2. The power converter circuit of claim 1, wherein the first, second and third transistors are MOSFETS.

3. The power converter circuit of claim 1, wherein the first controller circuit is configured to generate out of phase PWM signals to control the gate voltage of the first and second transistors respectively.

4. The power converter circuit of claim 1, wherein the threshold is about 1 to 2 volts above the fully charged voltage of the battery.

5. The power converter circuit of claim 1, wherein the first controller circuit is configured to adjust the gate voltage of the first and second transistors respectively so that a preset voltage between the positive and negative nodes of the photovoltaic panel is maintained.

6. The power converter circuit of claim 1, wherein the first controller circuit is configured to turn off the gate voltage of the first and second transistors for a predetermined period within every predetermined interval.

7. The power converter circuit of claim 6, wherein during the predetermined period, the open circuit voltage of the photovoltaic panel is measured repeatedly at a predetermined frequency, and the first controller circuit is configured to turn on the gate voltage of the first and second transistors when the difference between two consecutive measurements is less than a predetermined amount.

8. A solar power system comprising:
a plurality of photovoltaic panels, each photovoltaic panel comprising a charging node configured to provide a voltage limited current output;
a plurality of batteries, each battery comprising a sensing node configured to preventing the battery from being overcharged or the system from being overloaded;
a plurality of LED luminaires, each LED luminaire comprising a LED driving and control node configured to control the brightness and on/off status of the LED luminaire; and
a master controller being connected with the photovoltaic panels, the batteries and the LED luminaires through a bus, and configured to coordinate the operations thereof; wherein
the charging node comprising a power converter circuit for charging a battery, the power converter circuit comprising:
a first transistor being connected with a positive node and a negative node of a photovoltaic panel;
a second transistor being connected with the first transistor and the negative node of the photovoltaic panel;
a first controller circuit being configured to measure the voltage at a reference node and adjust the gate voltage of the first and second transistors respectively;
a third transistor being connected with the reference node and an output node; and
a second controller circuit being configured to control the gate voltage of the third transistor.

9. The solar power system of claim 8, wherein the reference node is connected to the second transistor through a LC network; the first controller circuit is configured to turn off the first and second transistors when the voltage at the reference node exceeds a threshold; and the second controller circuit is configured to prevent current from being fed back through the LC network.

10. The solar power system of claim 8, wherein the master controller comprises a wireless link configured to enable remote system monitoring and control.

11. The solar power system of claim 8, wherein the bus is a two wire power bus or a four wire power and data bus.

12. The solar power system of claim 8, wherein the master controller is configured to turn off all the charging nodes when all the batteries are fully charged.

13. The solar power system of claim 8, wherein the master controller is configured to collect data from each charging node to record how much power has been produced on a day to day basis.

14. The solar power system of claim 8, wherein the sensing node of each battery is configured to allow the battery to be disconnected from the bus when the battery is fully charged.

15. The solar power system of claim 8, wherein the master controller is configured to instruct a battery to be disconnected from the bus.

16. The solar power system of claim 8, wherein through the LED driving and control node, each luminaire is configured to send data indicating the performance of the luminaire back to the master controller.

17. A solar power system comprising:
at least a photovoltaic panel, the photovoltaic panel comprising a charging node configured to provide a current output;
at least a battery, the battery comprising a sensing node configured to preventing the battery from being overcharged or the system from being overloaded;
at least an LED luminaire, the LED luminaire comprising a LED driving and control node configured to control the LED luminaire; and
a master controller being connected with the photovoltaic panel, the battery and the LED luminaire through a bus, and configured to coordinate the operations thereof; wherein
the charging node comprising a power converter circuit for charging a battery, the power converter circuit comprising:
a first transistor being connected with a positive node and a negative node of a photovoltaic panel;
a second transistor being connected with the first transistor and the negative node of the photovoltaic panel; and
a first controller circuit being configured to measure the voltage at a reference node and adjust the gate voltage of the first and second transistors respectively;
the reference node being connected to the second transistor through a LC network;
the first controller circuit being configured to turn off the first and second transistors when the voltage at the reference node exceeds a threshold.

18. The solar power system of claim 17, wherein the threshold is about 1 to 2 volts above the fully charged voltage of the battery.

19. The solar power system of claim 17, wherein the first controller circuit is configured to turn off the gate voltage of the first and second transistors for a predetermined period within every predetermined interval.

20. The power converter circuit of claim 19, wherein during the predetermined period, the open circuit voltage of the photovoltaic panel is measured repeatedly at a predetermined frequency, and the first controller circuit is configured to turn on the gate voltage of the first and second transistors when the difference between two consecutive measurements is less than a predetermined amount.
